(19) United States
(12) Patent Application Publication
(10) Pub. No.: US 2018/0229486 A1
(43) Pub. Date: Aug. 16, 2018

(54) DECORATIVE LAMINATES WITH CORE LAYER SUBJECTED TO SODIUM ALGINATE TREATMENT

(71) Applicant: WILSONART LLC, Austin, TX (US)

(72) Inventor: Joel L. Williams, Temple, TX (US)

(21) Appl. No.: 15/893,840

(22) Filed: Feb. 12, 2018

Related U.S. Application Data
(60) Provisional application No. 62/458,148, filed on Feb. 13, 2017.

(51) Int. Cl. B32B 29/00; B32B 37/06; B32B 37/10; B32B 37/18; B44C 5/04; B31D 1/00; D21H 19/12

(52) U.S. Cl. CPC B32B 29/005; B31D 2201/00; B32B 37/10; B32B 37/18; B44C 5/0469; B31D 1/0075; B31D 1/0093; D21H 19/12; B32B 2255/12; B32B 2255/26; B32B 2260/028; B32B 2260/046; B32B 2307/748; B32B 2451/00; B32B 37/06

(57) ABSTRACT

A decorative laminate is manufactured in accordance with the method comprising preparing a decorative layer composed of a resin impregnated decorative sheet and preparing a core layer including an upper core sheet and a lowermost core sheet. The upper core sheet is prepared by impregnating a first paper with a resin. The lowermost core sheet is prepared by treating a second paper with sodium alginate to produce a sodium alginate treated paper and then impregnating the sodium alginate treated paper with resin. The decorative layer and the core layer are stacked. The decorative layer and the core layer are consolidated under heat and pressure to form the decorative laminate.

### CROSS REFERENCE TO RELATED APPLICATION

This application claims the benefit of U.S. Provisional Patent Application Ser. No. 62/458,148, entitled “DECORATIVE LAMINATES WITH CORE LAYER SUBJECTED TO SODIUM ALGINATE TREATMENT,” filed Feb. 13, 2017.

### FIELD OF THE INVENTION

The invention relates to a decorative laminate. In particular, the invention relates to decorative laminates wherein the exposed sheet at the bottom of the decorative laminate is subjected to a sodium alginate treatment.

### BACKGROUND

Decorative laminates are generally constructed from a plurality of synthetic resin impregnated paper sheets bonded under heat and pressure to form a unitary structure. With regard to the manufacture of high pressure laminates, the decorative laminate sheet assembly includes at least a core of one or more phenol formaldehyde resin impregnated sheets and a melamine impregnated decorative sheet. The decorative sheet may be further covered with a transparent melamine impregnated overlay layer.

The decorative sheet provides the laminate with an attractive appearance. The decorative sheet and the overlay layer dictate the surface characteristics of the decorative laminate. For example, the composition of the decorative sheet and overlay layer dictates the decorative laminate's resistance to chemical agents, heat, light, impact and abrasion.

Decorative sheets are commonly manufactured from high quality 60-205 grams/meter², pigment filled, alpha cellulose paper impregnated with a water alcohol or water solution of melamine-formaldehyde resin. The resin impregnated decorative sheets are subsequently dried, partially cured, and finally cut into sheets. The pigment filled, alpha cellulose paper of the decorative sheet, may include a solid color, a decorative design, or a roto-gravure reproduction of natural materials, such as, wood, marble, leather, abstract design, etc. The aesthetic characteristics of the cellulose paper are revealed as the laminate's decorative design upon completion of the manufacture of the decorative laminate.

The core, or base, functions to impart rigidity and impact resistance to the laminate. Prior to stacking, the paper sheets of the core are impregnated with a water alcohol or water solution of phenol formaldehyde resin, dried and partially cured in a hot oven. The cured laminate is then cut into predetermined shapes used to assemble the laminate layer. The core may, for example, include a plurality of sheets of 160 to 550 grams/meter² basis weight Kraft paper, impregnated with phenol formaldehyde resin, wherein the phenol formaldehyde resin is generally 25% to 35% of the final weight of the impregnated or coated core sheet. The Kraft paper is impregnated throughout and bonded with a substantially cured phenol formaldehyde resin which has been converted to a thermoset state during the initial laminating step.

Multiple laminate lay-ups are commonly pressed at the same time. When the laminate lay-ups are stacked, care must be taken to ensure that the laminate sheet assemblies do not stick together after the application of heat and pressure. Where the bottom sides of the laminate lay-ups are positioned in a facing relationship during the application of heat and pressure, a release agent is commonly applied to the bottom sheets of the laminate lay-ups such that the bottom sheets do not stick together and may be readily separated after the application of heat and pressure. Thereafter, the bottom layer of the resulting decorative laminate must be sanded to remove the release agent before the decorative laminate may be adhesively bonded to a substrate. Consequently, the use of these release agents adds expense and processing time to the manufacture of decorative laminates.

As a result, the Kraft paper on the backside of high pressure decorative laminates, which must be capable of release from adjacent laminate lay-ups, contains a Kraft paper that has been coated with a sodium alginate release material on at least the exposed side of the sheet. The sodium alginate is applied by machines which are capable of applying release coatings and drying coatings to specified moisture contents. The sodium alginate is applied to rolls of pre-made/pre-wound material after the paper is made.

A solid substrate may be bonded to the laminate where additional rigidity is required. Substrates are generally composed of a pre-cured plastic laminate, such as glass fiber-reinforced thermoset polyester resin laminates and the like; a wood product, such as hardboard, wood waste or particle boards, plywood and the like; a mineral base board, such as, cement-asbestos board, sheet rock, plaster board, and the like; or a combination of substrates. The substrate is commonly applied to the phenol formaldehyde resin impregnated sheets making up the core only after the laminate lay-up is pressed and heated to form the final decorative laminate.

Decorative laminates are generally manufactured by stacking the resin impregnated core sheets, the decorative sheet and the overlay layer to form a laminate sheet assembly, or laminate lay-up. The laminate lay-up is placed between steel press plates and subjected to temperatures in the range of about 121° Celsius to 160° Celsius, preferably 131° Celsius, and pressure of about 56.24 kilograms/centimeter² to 112.48 kilograms/centimeter², preferably 85 kilograms/centimeter², for a time sufficient to consolidate the laminate and cure the resins (generally about 25 minutes to an hour). The pressure and heat force the resin in the paper sheets to flow, cure and consolidate the sheets into a unitary laminated mass referred to in the art as a high pressure decorative laminate. Finally, the formed decorative laminate is bonded to a reinforcing substrate, such as, plywood, hardboard, asbestos board, particle board or the like.

### SUMMARY OF THE INVENTION

It is, therefore, an object of the present invention to provide a decorative laminate including a decorative layer composed of a resin impregnated decorative sheet and a core layer including an upper core sheet and a lowermost core sheet. The upper core sheet is resin impregnated, and the lowermost core sheet is treated with sodium alginate and resin impregnated.

It is also an object of the present invention to provide a decorative laminate including an overlay paper layer positioned on top of the decorative layer.

It is another object of the present invention to provide a decorative laminate wherein the upper core sheet is Kraft paper resin impregnated with phenol formaldehyde resin.

It is a further object of the present invention to provide a decorative laminate wherein the lowermost core sheet is Kraft paper resin impregnated with phenol formaldehyde resin.

It is also an object of the present invention to provide a decorative laminate wherein the sodium alginate is part of a sodium alginate mixture composed of water, sodium alginate, a release agent, and a defoamer.

It is another object of the present invention to provide a decorative laminate manufactured in accordance with the method comprising preparing a decorative layer composed of a resin impregnated decorative sheet and preparing a core layer including an upper core sheet and a lowermost core sheet. The upper core sheet is prepared by impregnating a first paper with a resin. The lowermost core sheet is prepared by treating a second paper with sodium alginate to produce a sodium alginate treated paper and then impregnating the sodium alginate treated paper with resin. The decorative layer and the core layer are stacked. The decorative layer and the core layer are consolidated under heat and pressure to form the decorative laminate.

It is a further object of the present invention to provide a decorative laminate wherein preparation of the lowermost core sheet includes applying a coating of sodium alginate to the second paper during production thereof.

It is also an object of the present invention to provide a decorative laminate wherein the coating is only applied to one side of the second paper.

It is another object of the present invention to provide a method for making decorative laminate as described above.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the decorative laminate in accordance with a preferred embodiment of the present invention.

FIG. 2 is a detailed schematic of the bottom second resin impregnated core sheet of the decorative laminate disclosed in FIG. 1.

FIG. 3 is a schematic of the stacking and manufacturing process employed in accordance with the present invention.

FIG. 4 is a schematic of the paper making machine employed in accordance with the present invention.

### DETAILED DESCRIPTION

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

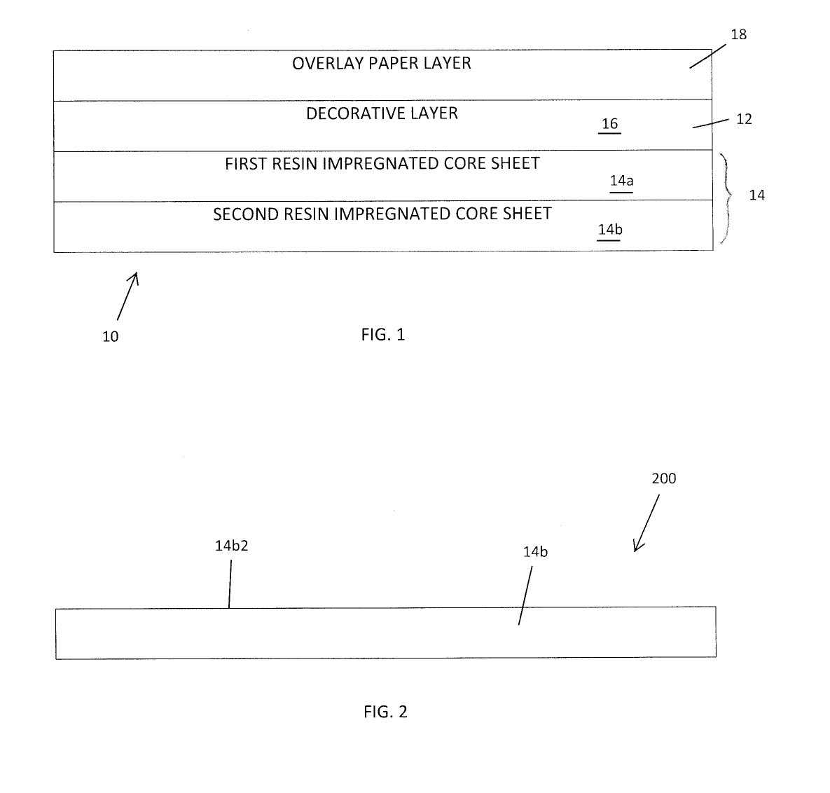

Referring now to the drawings, an embodiment of the high pressure decorative laminate 10 disclosed herein is illustrated in FIG. 1. Briefly, and as will be described in greater detail below, the decorative laminate 10 includes a decorative layer 12 and a core layer 14. The high pressure decorative laminate 10 in accordance with a preferred embodiment also includes an overlay paper layer 18. The decorative layer 12 is composed of a resin impregnated decorative sheet 16. The core layer 14 is composed of plural core sheets 14a, 14b of core paper.

As will be explained below in detail, the upper, top (or first) core sheet 14a is impregnated with phenol formaldehyde resin prior to the consolidation of the decorative laminate 10 via the application of the heat and pressure, while the lowermost, bottom (or second) core sheet 14b is treated as described below prior to the consolidation of the decorative laminate 10 via the application of the heat and pressure and is ultimately impregnated with phenol formaldehyde resin when the phenol formaldehyde resin from the first core sheet 14a flows within the laminate lay-up 10′ during the application of the heat and pressure.

The lowermost resin impregnated core sheet 14b, that is, the exposed sheet at the bottom of the decorative laminate 10 is subjected to a sodium alginate treatment and is, therefore, referred to herein as the “sodium alginate treated paper” or “sodium alginate treated Kraft paper.”

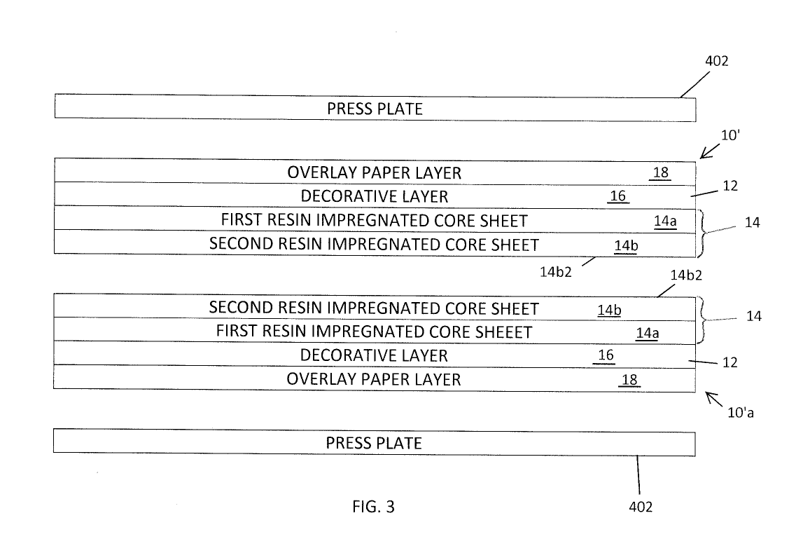

The decorative laminate 10 is manufactured by first preparing the overlay paper layer 18, the resin impregnated decorative sheet 16, the first core sheet 14a, and the second core sheet 14b. As shown with reference to FIG. 1, the overlay paper layer 18, the resin impregnated decorative sheet 16, the first core sheet 14a, and the second core sheet 14b are layered to form a laminate lay-up 10′ (as shown in FIG. 3), and the laminate lay-up 10′ is heated and pressed to consolidate and cure the laminate 10. It should be appreciated, however, that the layering pattern may be varied, somewhat, without departing from the spirit of the present disclosure.

The overlay paper layer 18 is preferably a melamine impregnated paper layer. The overlay paper layer 18 is preferably manufactured from a low basis weight transparent sheet impregnated with resin, for example, melamine. The resin impregnated overlay paper layer 18 is subsequently dried, partially cured and finally cut into sheets. While the paper may exhibit opaque properties prior to heating and pressing, the overlay paper layer 18 in the final fabricated laminate is preferably transparent to permit viewing of the decorative sheet positioned directly beneath the overlay paper layer 18.

The decorative layer 12 is composed of a conventional decorative sheet 16 positioned directly beneath the overlay paper layer 18. When the laminate 10 is fully heated and pressed, as will be discussed in detail below, the overlay paper layer 18 becomes translucent, fully exposing the decorative layer 12. The decorative layer 12 is chosen from a wide array of sheets. For example, the decorative layer 12 may be a solid color (for example, white) or may include an aesthetically appealing pattern.

The overlay paper layer 18 and the decorative layer 12 also dictate the surface characteristics of the final decorative laminate 10. For example, the composition of the overlay paper layer 18 and decorative layer 12 dictates the resistance of the decorative laminate 10 to chemical agents, heat, light, shock and abrasion.

As discussed above, the decorative layer 12 is composed of a sheet of decorative paper 16. The decorative sheets are commonly manufactured from high quality 60-205 grams/meter², pigment filled, alpha cellulose paper impregnated with a water alcohol or water solution of melamine-formaldehyde resin. The alpha cellulose paper, in accordance with an embodiment of the present disclosure, is impregnated with a resin content of approximately 50% or greater. The resin impregnated paper is subsequently dried, partially cured, and finally cut into properly sized sheets. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the laminate's decorative design upon completion of the decorative laminate.

The core layer 14 is preferably composed of at least the first and second core sheets 14a, 14b of Kraft (or core) paper, although other materials, and volume of sheets, may be used without departing from the spirit of the present disclosure. For example, the core layer 14 includes the first core sheet 14a composed of 160-550 grams/meter² basis weight Kraft paper. The Kraft paper of the upper, top first core sheet 14a is processed in a traditional manner and is, therefore, impregnated with a phenol formaldehyde resin composition and is partially cured (β-staged). In accordance with a preferred embodiment, the upper, top first core sheet 14a is impregnated with phenol formaldehyde resin such that the phenol formaldehyde resin is generally 25% to 35% of the final weight of the impregnated core sheet.

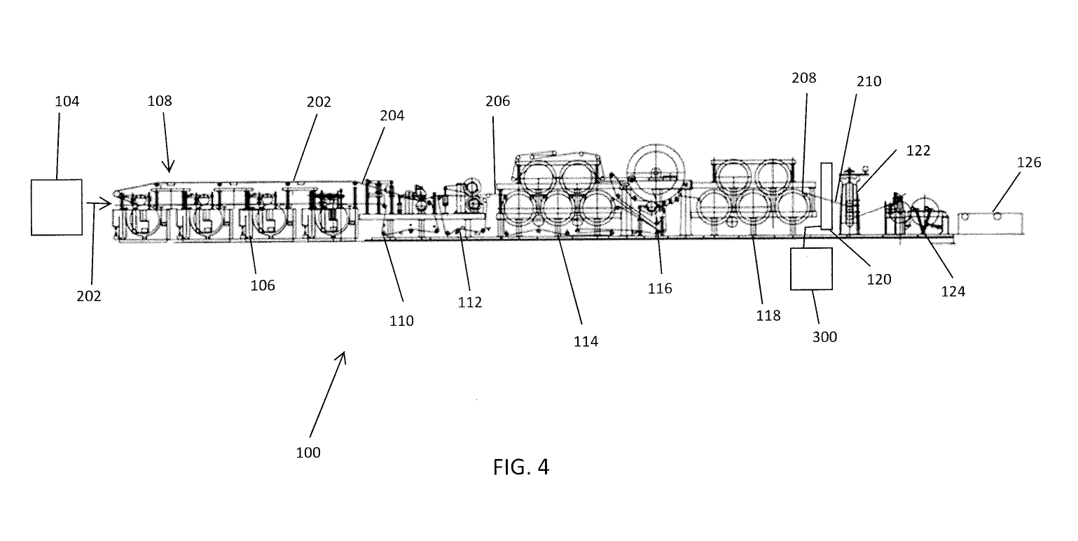

With regard to the lowermost, bottom second core sheet 14b, the Kraft paper is preferably 160 grams/meter² to 550 grams/meter² basis weight Kraft paper. However, the Kraft paper is manufactured in a distinctive manner as discussed with reference to FIG. 4. In particular, a coating of sodium alginate is applied to Kraft paper on a paper machine 100 as the Kraft paper is being produced (“sodium alginate treated Kraft paper 200”). In particular, the coating of sodium alginate is applied to the one side of the Kraft paper, which ultimately becomes the second side 14b2 of the second core sheet 14b when the layers of the decorative laminate 10 are ultimately layered for consolidation under heat and pressure. This allows high pressure laminate producers to eliminate coating Kraft paper in their manufacturing process and become more efficient by using this pre-coated material. The resulting sodium alginate treated Kraft paper used as the lowermost, bottom second core sheet 14b.

The sodium alginate treated Kraft paper 200, which ultimately is used as the second core sheet 14b, is manufactured in the manner described below and with reference to FIG. 4. An aqueous fluid containing cellulosic pulp and other papermaking ingredients is first formed in a conventional manner. Thereafter, the aqueous fluid (or slurry) 202 is delivered to a pulp thickener 104 where excess water is expressed. From the pulp thickener 104, the slurry 202 is deposited on a conventional former (for example, a Fourdrinier wire cloth) 106 in the mould section 108 of the paper making machine 100. After forming, the formed slurry 204 is pressed in a baby press 110 which is followed by further pressing in a press section 112. The formed and pressed slurry 206 is then heated in order to dry the material and produce a self-sustaining web of paper 208. This is accomplished in the pre-dryer section 114, the M. G. section (that is, a cylinder producing desirable surface characteristics) 116 and the post-dryer section 118 using conventional equipment and techniques. After drying, the web of paper 208 is subjected to the sodium alginate treatment in accordance with the present invention.

In particular, the sodium alginate mixture 300 is prepared prior to the start of the paper making process. For example, in order to create a 500 gallon (1,892.7 liter) mixture, 500 gallons (1,892.7 liters) of water are mixed with 75 pounds (34.0 kilograms) of sodium alginate, 6500 grams (229.28 ounces) of a release agent (preferably Pat-C-2725R release agent manufactured by E. und P. Würtz GmbH & Co. KG Würtz which is a lubricant and release agent for polymers), 2500 grams (88.18 ounces) of defoamer (preferably TROYKYD® D777 silicone modified defoamer manufactured by Troy Corporation), 750 grams (26.28 ounces) of red dye (preferably FC88941 Red Dye manufactured by Fentak PTY LTD). The sodium alginate mixture 300 is then agitated and mixed to the viscosity of 500-700 centipoise. In addition, or in place of, the disclosed Pat-C-2725R release agent manufactured by E. und P. Würtz GmbH & Co. KG Würtz, wax and/or silicone release agents may be used within the spirit of the present invention.

Thereafter, the sodium alginate mixture 300 is utilized in conjunction with a roll coater or nozzle application 120 for application to the web of paper 208 after the post-dryer section 118 and before the calendar section 122. In accordance with a preferred embodiment, the sodium alginate mixture 300 is only applied to one side of the web of paper 208, which ultimately becomes the second side 14b2 of the second core sheet 14b when the layers of the decorative laminate 10 are ultimately layered for consolidation under heat and pressure. Preferably, 18-24 pounds (8.16-10.89 kilograms) of sodium alginate mixture 300 is applied per ton (21.77 metric tons) of paper 208.

After application to the web of paper 208, the sodium alginate mixture 300 is dried using the heat from the paper exiting the post dryer section 118 (or the web of paper 208 may be dried using well known infrared heaters). It is appreciated that the sodium alginate must be dried to 3-4% volatile content and that the line speed of the paper machine 100, which can run anywhere from 300 feet per minute (91.44 meters per minute) to 1,000 feet per minute (304.8 meters per minute), will be determined based upon the drying system employed in accordance with the present invention. Ultimately, the sodium alginate treated web of paper 210 exiting the sodium alginate mixture application assembly 120 is approximately 150° Celsius to 130° Celsius.

After leaving the sodium alginate mixture application assembly 120, the treated web of paper 210 is subjected to a calendar section (or machine) 122, a pope reel section 124 and a sheet cutter 126 which ultimately process the paper in a conventional manner using well known equipment. In the sheet cutter 126, the treated web of paper 210 is cut into appropriate lengths and widths to form the sodium alginate treated Kraft paper 200 that is ultimately used in accordance with the present invention as the second core sheet 14b. It is important to note that the sodium alginate treated Kraft paper will not be impregnated with resin, but rather (and as is explained below in greater detail) the sodium alginate treated Kraft paper is paper will be collated as is, and ultimately layered with the second core sheet 14a, which is resin impregnated Kraft paper treated with phenolic resin in a conventional manner. The phenolic resin from the first core sheet 14a will fully penetrate the second core sheet 14b, that is, the sodium alginate treated Kraft paper, during the pressing process so as to consolidate the layers of the resulting decorative laminate.

Once the appropriate layers of the laminate are formed, the sheets are stacked in a conventional manner (with the lowermost, bottom second core sheet 14b at the bottom of the laminate lay-up 10′ and the second side 14b2 (that is, the side of the second core sheet coated with the sodium alginate mixture) of the bottom second resin impregnated core sheet 14b facing outwardly away from the remainder of the laminate lay-up 10′. As shown in FIG. 3, a first laminate lay-up 10′ stacked as described above is then stacked with a second laminate lay-up 10′a stacked as described above with the second sides of the bottom second resin impregnated core sheets 14b positioned in a facing relationship. The first and second laminate lay-ups 10′, 10′a, are then positioned between steel press plates 402 with the overlay sheets 18 of the respective first laminate lay-up 10′ and the second laminate lay-up 10′a in direct contact with the steel press plates 102. The laminate lay-ups 100 are then subjected to temperatures in the range of 121° Celsius to 160° Celsius, preferably 131° Celsius, and pressure of about 56.24 kilograms/centimeter² to 112.48 kilograms/centimeter², preferably 85 kilograms/centimeter², for a time sufficient to consolidate the laminate and cure the resins (generally about 25 minutes to an hour). The laminates are then cooled for approximately minutes under pressure before it is ready for further processing in preparation for its use in the manufacture of various products.

While specific temperatures, pressures and times are described above, it should be appreciated that a variety of pressing techniques may be used without departing from the spirit of the present disclosure.

The pressure and heat force the resin in the paper sheets to flow, cure and consolidate the sheets into a unitary laminated mass referred to in the art as a decorative high pressure laminate. Generally, more than one laminate is formed at one time.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by appended claims.

1. A decorative laminate comprising:
a decorative layer composed of a resin impregnated decorative sheet; and
a core layer including an upper core sheet and a lowermost core sheet, wherein the upper core sheet is resin impregnated and the lowermost core sheet is treated with sodium alginate and resin impregnated.

2. The decorative laminate according to claim 1, further including an overlay paper layer positioned on top of the decorative layer.

3. The decorative laminate according to claim 1, wherein the upper core sheet is Kraft paper resin impregnated with phenol formaldehyde resin.

4. The decorative laminate according to claim 3, wherein the lowermost core sheet is Kraft paper resin impregnated with phenol formaldehyde resin.

5. The decorative laminate according to claim 1, wherein the sodium alginate is part of a sodium alginate mixture composed of water, sodium alginate, a release agent, and a defoamer.

6. A decorative laminate manufactured in accordance with the method comprising:
preparing a decorative layer composed of a resin impregnated decorative sheet; and
preparing a core layer including an upper core sheet and a lowermost core sheet, wherein the upper core sheet is prepared by impregnating a first paper with a resin and the lowermost core sheet is prepared by treating a second paper with sodium alginate to produce a sodium alginate treated paper and then impregnating the sodium alginate treated paper with resin;
stacking the decorative layer and the core layer; and
consolidating the decorative layer and the core layer under heat and pressure to form the decorative laminate.

7. The decorative laminate according to claim 6, further including an overlay paper layer positioned on top of the decorative layer.

8. The decorative laminate according to claim 6, wherein the upper core sheet is Kraft paper impregnated with phenol formaldehyde resin.

9. The decorative laminate according to claim 8, wherein the lowermost core sheet is Kraft paper impregnated with phenol formaldehyde resin.

10. The decorative laminate according to claim 6, wherein the sodium alginate is part of a sodium alginate mixture composed of water, sodium alginate, a release agent, and a defoamer.

11. The decorative laminate according to claim 6, wherein preparation of the lowermost core sheet includes applying a coating of sodium alginate to the second paper during production thereof.

12. The decorative laminate according to claim 11, wherein the coating is only applied to one side of the second paper.

13. A method for making decorative laminate, comprising:
preparing a decorative layer composed of a resin impregnated decorative sheet; and
preparing a core layer including an upper core sheet and a lowermost core sheet, wherein the upper core sheet is prepared by impregnating a first paper with a resin and the lowermost core sheet is prepared by treating a second paper with sodium alginate to produce a sodium alginate treated paper and then impregnating the sodium alginate treated paper with resin;
stacking the decorative layer and the core layer; and
consolidating the decorative layer and the core layer under heat and pressure to form the decorative laminate.

14. The decorative laminate according to claim 13, further including an overlay paper layer positioned on top of the decorative layer.

15. The decorative laminate according to claim 13, wherein the upper core sheet is Kraft paper impregnated with phenol formaldehyde resin.

16. The decorative laminate according to claim 15, wherein the lowermost core sheet is Kraft paper impregnated with phenol formaldehyde resin.

17. The decorative laminate according to claim 13, wherein the sodium alginate is part of a sodium alginate mixture composed of water, sodium alginate, a release agent, and a defoamer.

18. The decorative laminate according to claim 13, wherein preparation of the lowermost core sheet includes applying a coating of sodium alginate to the second paper during production thereof.

19. The decorative laminate according to claim 18, wherein the sodium alginate is part of a sodium alginate mixture composed of water, sodium alginate, a release agent, and a defoamer.

20. The decorative laminate according to claim 18, wherein the coating is only applied to one side of the second paper.
